(19) United States
(12) Patent Application Publication
(10) Pub. No.: US 2011/0002117 A1
(43) Pub. Date: Jan. 6, 2011

(54) OPTICAL DISC DRIVE

(75) Inventors: Hiroshi KAYAMA, Osaka (JP); Yuichi TAKAHASHI, Nara (JP); Kazuo MOMOO, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(73) Assignee: PANASONIC CORPORATION, Osaka (JP)

(21) Appl. No.: 12/813,671

(22) Filed: Jun. 11, 2010

(30) Foreign Application Priority Data
Jun. 16, 2009 (JP) 2009-142884

(51) Int. Cl. F21V 5/00

(52) U.S. Cl. 362/235

(57) ABSTRACT

An optical disc drive includes: at least one light source; an objective lens configured to focus the light that has been emitted from the at least one light source; a chromatic aberration compensation element, which is arranged on an optical path between the at least one light source and the objective lens in order to compensate for chromatic aberration that has been produced by the objective lens; and an actuator configured to change a position of the objective lens. The actuator changes the position of the objective lens in a tracking direction by a magnitude of an offset, which is determined by a variation in wavelength of the light to be produced when the power of the light emitted from the at least one light source changes.

### BACKGROUND OF THE INVENTION

1. Field of the Invention

The present invention relates to an optical pickup device for reading and/or writing information using a laser beam and also relates to an optical disc drive including such an optical pickup device.

2. Description of the Related Art

An optical pickup device that can both read and write data from/on an optical disc usually changes the power of the laser beam emitted according to its mode of operation (i.e., whether the device is going to write data or read data).

However, if the power of the laser beam emitted were changed in order to start writing data after data has been read, then the wavelength of the laser beam would vary. And such a variation in wavelength would cause focus position shifting (which will also be referred to herein as “chromatic aberration”).

As for a DVD, from/on which data is read and written using a laser beam with a wavelength of around 650 nm and an objective lens with a numerical aperture (NA) of 0.60, people believe that the chromatic aberration, if any, should not be a big problem.

Nevertheless, as the storage capacities of information storage media have been increased by leaps and bounds recently, the chromatic aberration has become an increasingly serious problem. For example, a Blu-ray Disc (which will be referred to herein as a “BD”) uses a laser beam with a wavelength of approximately 400 nm and an objective lens with a numerical aperture (NA) of 0.80. That is to say, the wavelength of light sources for information storage media has been decreasing and the NA of objective lenses for use to play them has been increasing year by year.

In such a short wave range, an optical material to make lenses, for example, has so great a dispersion that even a slight variation in wavelength would vary the refractive index of the optical material significantly. For that reason, the chromatic aberration has become such a big issue to threaten the stability of focus control. Under the circumstances such as these, it has become more and more necessary nowadays for optical pickup devices to consider how to compensate for such chromatic aberration.

In order to minimize the chromatic aberration, as disclosed in Japanese Patent Applications Laid-Open Publications Nos. 64-19316, 7-294707, and 2005-50504, a technique for providing an objective lens element with a chromatic aberration compensation function, a technique for providing a collimator lens, which is arranged between a light source and an objective lens element, with a chromatic aberration compensation function, and a technique for providing the chromatic aberration compensation function for both a collimator lens and an aberration compensation element have been proposed.

In an optical pickup device for compensating for the chromatic aberration using a chromatic aberration compensation element, the chromatic aberration compensation element is connected to an objective lens actuator so as to be driven along with the objective lens. As a result, the laser beam passing through the objective lens can have its chromatic aberration reduced and a focus control can get done accurately.

In a thin optical pickup device, of which the size is regulated in the thickness direction (or height direction), however, sometimes it is difficult to integrate the chromatic aberration compensation element with the actuator. In that case, the chromatic aberration compensation element is arranged before a high reflecting mirror as viewed from the laser light source. Such an arrangement, however, has the following problem.

Suppose a situation where while data is being read from an optical disc, the objective lens has shifted due to the eccentricity of the disc, thus causing some misalignment between the optical axis of the objective lens and that of the chromatic aberration compensation element. If the power of the laser beam emitted is increased in such a situation to start a write operation after that, then the wavelength of the laser beam varies. As a result, the beam spot of the laser beam moves in the tracking direction, thus affecting the stability of the tracking control. As used herein, the “tracking direction” is defined perpendicularly to the tracks on a plane that is parallel to the storage layer of an optical disc.

FIGS. 6(a) through 6(d) illustrate the relative positions of a chromatic aberration compensation element 402, an objective lens 401 and the focus position while a read or write operation is being performed on a BD-R or a BD-RE. Only the chromatic aberration compensation element 402 and the objective lens 401 are illustrated in FIG. 6 and the other optical members are not illustrated for the sake of simplicity.

Specifically, FIG. 6(a) illustrates a situation where the objective lens 401 does not shift at all while data is being read from an optical disc. The incoming light, which has been incident as nearly a parallel light beam on the chromatic aberration compensation element 402, is transformed into a slightly divergent light beam, which is then transmitted through the objective lens 401 and condensed. In such a situation, the respective centers of the chromatic aberration compensation element 402 and the objective lens 401 both agree with the center 403 of the optical axis.

On the other hand, FIG. 6(b) illustrates a situation where the objective lens has shifted so as to keep up with the grooves (or tracks) on the optical disc while data is being read from the optical disc. The position of the objective lens that has not shifted yet is indicated by the dotted ellipse, while that of the objective lens that has already shifted is indicated by the solid ellipse. In the example illustrated in FIG. 6(b), the objective lens has shifted to the right, so has its focus position. That is to say, the center 404 of the objective lens has shifted to the right with respect to the center 403 of the optical axis. But the focus position is still located near the center of the objective lens.

Meanwhile, FIG. 6(c) illustrates a situation where the objective lens does not shift at all while data is being written on the optical disc. When a write operation is performed, the laser output (i.e., the power of the laser beam emitted) rises to increase the wavelength of the laser beam by several nanometers. In FIG. 6(c), the light beam, of which the wavelength has not varied yet, is indicated by the dashed lines, while the light beam, of which the wavelength has varied, is indicated by the solid lines. Since the wavelength has varied, the light beam is somewhat diverged by the chromatic aberration compensation element 402, and is also slightly focused by the objective lens 401, compared to what the light beam is during reading. As a result, as shown in FIG. 6(c), the influence of the wavelength variation can be canceled and the shift of the focus position in the focus direction can be reduced.

FIG. 6(d) illustrates a situation where the objective lens has shifted so as to keep up with the grooves on the optical disc while data is being written on the optical disc. If the objective lens 401 shifts from the position indicated by the dotted ellipse to the one indicated by the solid ellipse when the light beam is somewhat diverged by the chromatic aberration compensation element 402 compared to what it is during reading, the focus position will shift further to the right than it is during reading. That is to say, the focus position will shift from its initial position 403 to the position 405 by way of the position 404.

It should be noted that the magnitudes of the lens shift and the focus position shift illustrated in FIG. 6 are much bigger than the actual ones to make their concepts easily understandable. Actually, however, the magnitude of the objective lens shift is on the order of several hundred μm and the magnitude of the focus position shift in the tracking direction due to the chromatic aberration is just a matter of less than 1 μm.

Even if the modes of operation are changed from the read mode shown in FIG. 6(a) into the write mode shown in FIG. 6(c), the focus position will shift in neither the focus direction nor the tracking direction, thus causing no problem.

However, if the power of the laser beam emitted is changed to switch from the read mode shown in FIG. 6(b), in which the objective lens shifts, into the write mode shown in FIG. 6(d), then the focus position will move in the tracking direction.

FIG. 7 shows how much the focus position will shift as the disc make one turn while a tracking control is performed on either a BD-R or a BD-RE with good stability. As used herein, the “magnitude of shift” refers to how much the focus position shifts in the tracking direction. Therefore, FIG. 7 shows a variation in the magnitude of eccentricity of the disc.

In FIG. 7, the solid curve indicates how the focus position 201 moves during a read operation, while the dashed curve indicates how the focus position 202 moves during a write operation. Meanwhile, the objective lens stays at the same position, no matter whether the mode of operation is reading or writing. But the power of the laser beam emitted to perform a write operation is greater than that of the laser beam emitted to perform a read operation.

Suppose the power of the laser beam emitted is changed at a time A shown in FIG. 7 to make a transition from the read mode into the write mode. This transition corresponds to a switch from the read mode shown in FIG. 6(b) to the write mode shown in FIG. 6(d). Also, suppose another transition is made from the read mode into the write mode at a time B shown in FIG. 7. This transition corresponds to a switch from the read mode shown in FIG. 6(a) to the write mode shown in FIG. 6(c).

The power of the laser beam emitted varies at a response speed of several nanoseconds (ns), and therefore, the wavelength also varies in just a matter of several ns. To keep up with such a wavelength variation, the operating frequency of the tracking control should be high. Actually, however, the operating frequency of the tracking control falls within a range of several kHz, which is too low to make the tracking control immediately catch up with the variation in the power of the laser beam emitted. This is the reason why the focus position shifts in the tracking direction as described above.

FIG. 8 shows how the waveform of a tracking error (TE) signal varies when the power of the laser beam emitted is changed from a readout power into a recording power. As shown in FIG. 8, at a writing start time A, a significant offset is produced and then the amplitude of the TE signal focuses toward zero through a tracking control.

If the magnitude of the focus position shift is great, then the tracking control will lose its stability. In the worst case scenario, a write operation could be started while the tracking control is not established. In that case, data stored in neighboring tracks could be destroyed, thus possibly making the given optical disc unusable.

### SUMMARY OF THE INVENTION

It is therefore an object of the present invention to get a tracking control done with stability on an optical disc drive with an optical pickup device including a chromatic aberration compensation element.

An optical disc drive according to the present invention includes: at least one light source; an objective lens configured to focus light that has been emitted from the at least one light source; a chromatic aberration compensation element, which is arranged on an optical path between the at least one light source and the objective lens in order to compensate for chromatic aberration that has been produced by the objective lens; and an actuator configured to change a position of the objective lens. The actuator changes the position of the objective lens in a tracking direction by a magnitude of an offset, which is determined by a variation in wavelength of the light to be produced when a power of the light emitted from the at least one light source changes.

Relative positions of the objective lens and the chromatic aberration compensation element may change.

The optical disc drive may further include a mirror, which is arranged on the optical path between the at least one light source and the objective lens, and the chromatic aberration compensation element may be arranged between the at least one light source and the mirror.

The optical disc drive may further include an actuator driving section configured to determine the magnitude of the offset by magnitude of the variation in the wavelength of the light and magnitude of misalignment between the optical axes of the objective lens and the chromatic aberration compensation element.

The actuator driving section may determine the magnitude of misalignment between the optical axes of the objective lens and the chromatic aberration compensation element by a drive voltage applied to the actuator.

The optical disc drive may further include: a controller configured to generate a writing control signal; and a laser driver section configured to change the power of the light emitted from the light source in accordance with the writing control signal. Before the laser driver section changes the power of the light emitted, the actuator driving section may change the position of the objective lens in the tracking direction. After the position of the objective lens has been changed, the controller may generate the writing control signal and the laser driver section may change the power of the light emitted.

Before the power of the light emitted is changed, the controller may output an off-track control signal to the actuator driving section to instruct the actuator driving section to change the position of the objective lens. On receiving the off-track control signal, the actuator driving section may change the position of the objective lens in the tracking direction.

After the position of the objective lens has been changed, the controller may generate the writing control signal, thereby changing the power of the light emitted from a readout power into a recording power.

The at least one light source may include a first light source configured to emit light with a first wavelength and a second light source configured to emit light with a second wavelength, which is shorter than the first wavelength. When the second light source emits the light with the second wavelength, the actuator may change the position of the objective lens in the tracking direction by the magnitude of an offset, which is determined by a variation in the second wavelength to be produced when the power of the light emitted from the second light source changes.

Data defining a relation between the magnitude of the variation in the wavelength of the light, the magnitude of misalignment between the optical axes of the objective lens and the chromatic aberration compensation element, and the magnitude of the offset may be stored in advance in a tracking control section, which may determine the magnitude of the offset by reference to that data.

According to the present invention, the actuator changes the position of the objective lens in the tracking direction by the magnitude of an offset, which is determined by a variation in the wavelength of the light to be produced when the power of the light emitted from the at least one light source changes. That is why even if the power of the laser beam emitted is changed when misalignment occurs in the tracking direction between the respective optical axes of the objective lens and the chromatic aberration compensation element, the influence of off-track due to the wavelength variation can be reduced. As a result, the stability of the tracking control can be ensured and the decline in the quality of writing can be minimized.

### BRIEF DESCRIPTION OF THE DRAWINGS

Portions (a) and (b) of FIG. 1 illustrate an exemplary arrangement for an optical disc drive 100 as a preferred embodiment of the present invention.

FIG. 2 illustrates a detailed configuration for a tracking control section 123a in a servo section 123.

FIG. 3 is a flowchart showing the procedure of the processing carried out by an optical disc drive 100 according to a preferred embodiment of the present invention.

FIG. 4 shows the waveform of a TE signal before and after a write operation is started in a preferred embodiment of the present invention.

FIG. 5 illustrates how the light beam spot moves on an optical disc 101 when a write operation is performed with the power changed from a readout power into a recording power.

FIGS. 6(a) through 6(d) illustrate the relative positions of a chromatic aberration compensation element 402, an objective lens 401 and the focus position while a read or write operation is being performed on a BD-R or a BD-RE.

FIG. 7 shows how much the focus position will shift as the disc make one turn while a tracking control is performed on either a BD-R or a BD-RE with good stability.

FIG. 8 shows how the waveform of a tracking error (TE) signal varies when the power of the laser beam emitted is changed from a readout power into a recording power.

### DETAILED DESCRIPTION OF PREFERRED EMBODIMENTS

The present invention is applicable for use in an optical pickup device in which an objective lens and a chromatic aberration compensation element are arranged separately from each other and their relative positions are subject to change.

First of all, it will be described on what principle an optical disc drive, including the optical pickup device of the present invention, operates.

Suppose the position of an objective lens is controlled so as to keep up with the eccentricity of an optical disc such as a BD-R or a BD-RE being played. In such a situation, the respective optical axes of the objective lens and the chromatic aberration compensation element are not aligned with each other. And if the power of the laser beam emitted is changed while a write operation is performed after that, the wavelength of the laser beam varies, thus shifting the focus position in the tracking direction due to that wavelength variation.

According to the present invention, before the power of the laser beam emitted is changed to start a write operation, the position of the objective lens is changed in order to at least reduce significantly, and ideally cancel, the influence of focus position shift due to the variation in wavelength. Specifically, the magnitude of present eccentricity of the optical disc is determined based on the voltage applied to the actuator to drive it in the tracking direction, and the actuator is driven in such a direction as to cancel the shift in the tracking direction according to the magnitude of that eccentricity. And after the position of the objective lens has been changed, the power of the laser beam emitted is changed. When the focus position shifts due to the wavelength variation, the shifted focus position will be right on the target track of writing after all. As a result, the influence of off-track due to the wavelength variation can be reduced, the stability of tracking control can be ensured, and the decline in the quality of writing can be minimized.

As a result, an optical pickup device of a reduced size that can get a read/write operation done on an optical disc with good stability and an optical disc drive including such an optical pickup device are provided.

Hereinafter, preferred embodiments of an optical pickup device and optical disc drive according to the present invention will be described with reference to the accompanying drawings. An optical disc drive 100 to be described below as a preferred embodiment of the present invention is supposed to have the function of writing information on an optical disc such as a BD-R or a BD-RE and the function of reading information from the optical disc. Also, in the following description, the power of the laser beam emitted to write information will be referred to herein as “recording power”, and the power of the laser beam emitted to read information as “readout power”, respectively.

Portions (a) and (b) of FIG. 1 illustrate an exemplary arrangement for an optical disc drive 100 as a preferred embodiment of the present invention. Specifically, portion (a) of FIG. 1 illustrates a cross section of the optical disc drive 100 as viewed in the thickness direction of a given optical disc 101 (i.e., perpendicularly to its information storage layer, or in the focus direction). On the other hand, portion (b) of FIG. 1 is a cross-sectional view as viewed parallel to the surface of the optical disc 101 (i.e., parallel to the information storage layer, or in the tracking direction). In portion (a) of FIG. 1, the double-headed arrows F and T indicate the “focus direction” and the “tracking direction”, respectively.

As shown in portion (a) of FIG. 1, the optical disc drive 100 includes an optical pickup device 200 and a spindle motor 117. On the other hand, as shown in portion (b) of FIG. 1, the optical disc drive 100 further includes a preamplifier 121, a signal processing section 122, a servo section 123, a controller 124 and a laser driver section 125.

The optical pickup device 200 includes a blue laser beam source 102, a diffraction grating 104, a collimator lens 107, a PBS 108, a beam expander 109, an actuator 110, a detector lens 115, a photodetector 116, the spindle motor 117, a quarter wave plate 131, an objective lens 132, another actuator 133, a reflective mirror 136, and a chromatic aberration compensation element 137.

Hereinafter, it will be described with reference to portions (a) and (b) of FIG. 1 what optical path the laser beam follows in the optical pickup device 200. On top of that, it will also be described how the respective elements of the optical pickup device 200 work and exactly how the light reflected from the optical disc is used to control the optical disc drive 100. As shown in FIG. 1, the light emitted from the blue laser beam source (which will be referred to herein as the “blue LD”) 102 is incident on the diffraction grating 104, which splits the incident light into a main beam (i.e., zero-order diffracted beam) and sub-beams (±first-order diffracted beams). Next, the main and sub-beams enter the collimator lens 107, and are transformed by the collimator lens 107 into a substantially parallel, divergent light beam. Then the divergent light beam thus produced is transmitted through the polarization beam splitter (PBS) 108, transformed into a substantially parallel light beam again by the beam expander 109, transmitted through the chromatic aberration compensation element 137, reflected by the reflective mirror 136, and then incident on the quarter-wave plate 131.

The beam expander 109 is driven by the actuator 110 and used to cancel the spherical aberration that has been produced due to a variation in the thickness of the transparent layer of the optical disc. As used herein, the “transparent layer” refers to the light transmissive layer of the optical disc, which is arranged between the disc surface on which the laser beam is incident and the information storage layer (not shown).

The incident light, which has been linearly polarized until then, is transformed by the quarter-wave plate 131 into circularly polarized light, which is then condensed by the objective lens 132 onto the surface of the optical disc 101 being turned by the spindle motor 117. The position of the objective lens 132 is changed by the actuator 133 in the focus direction F and in the tracking direction T (i.e., a track transverse direction).

The light reflected from the optical disc passes through the objective lens 132 and then enters the quarter-wave plate 131 again. This circularly polarized light is transformed by the quarter-wave plate 131 into linearly polarized light, of which the polarization direction is perpendicular to that of the light that was going toward the disc. Then, the linearly polarized light is reflected by the reflective mirror 136, transmitted through the chromatic aberration compensation element 137 and the beam expander 109, reflected by the PBS 108, and then condensed by the detector lens 115 onto the photodetector 116.

The photodetector 116 outputs a detection signal representing the intensity of the light received to the preamplifier 121, which generates a focus error signal, a tracking error signal and a radio frequency signal (which will be referred to herein as “FE signal”, “TE signal” and “RF signal”, respectively) based on the detection signal. Specifically, the FE signal indicates that the beam spot formed on the information storage layer of the optical disc 101 has not been condensed to the predetermined degree yet because the objective lens 132 has shifted from its appropriate position in the focus direction F. On the other hand, the TE signal indicates that the beam spot formed on the information storage layer of the optical disc 101 has shifted in the tracking direction because the objective lens 132 has shifted from its appropriate position in the tracking direction T. And the RF signal represents not only the data and information that have been written as pits or marks on the information storage layer of the optical disc 101 but also the address information of tracks from/on which the data is read or written as well.

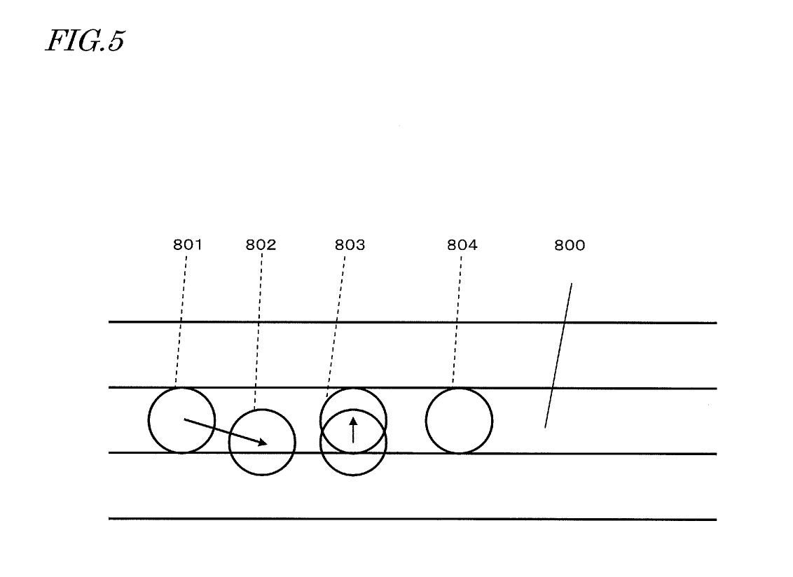

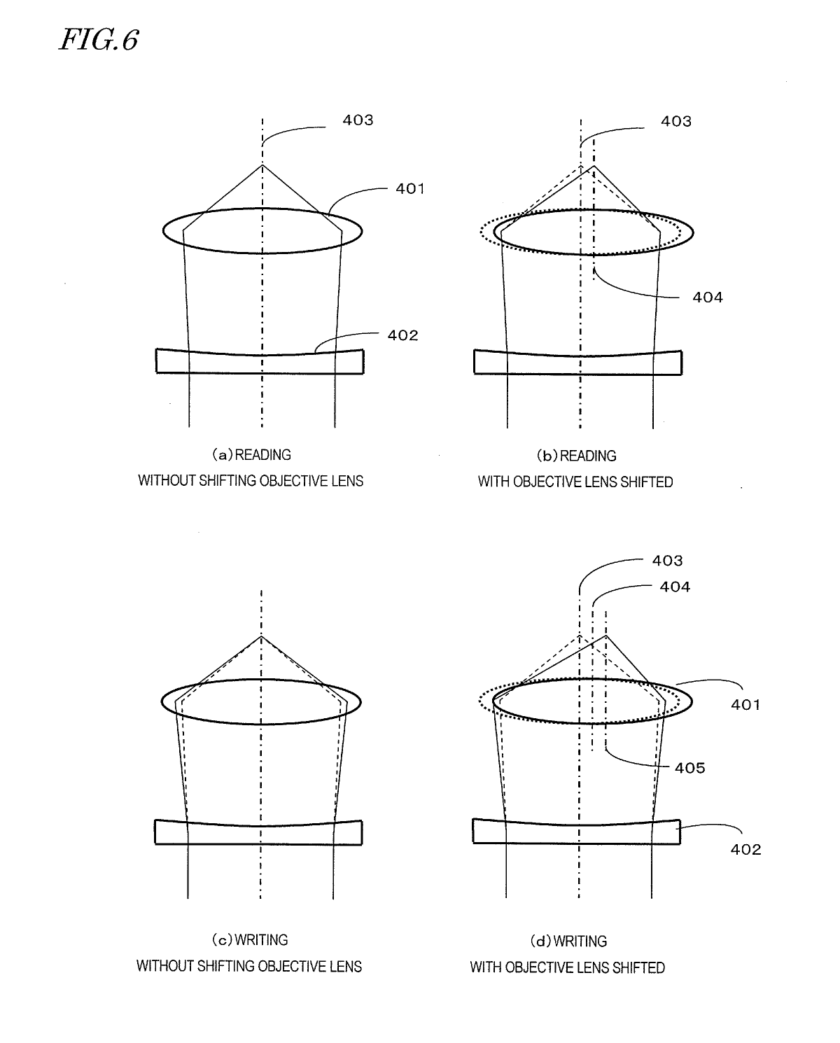

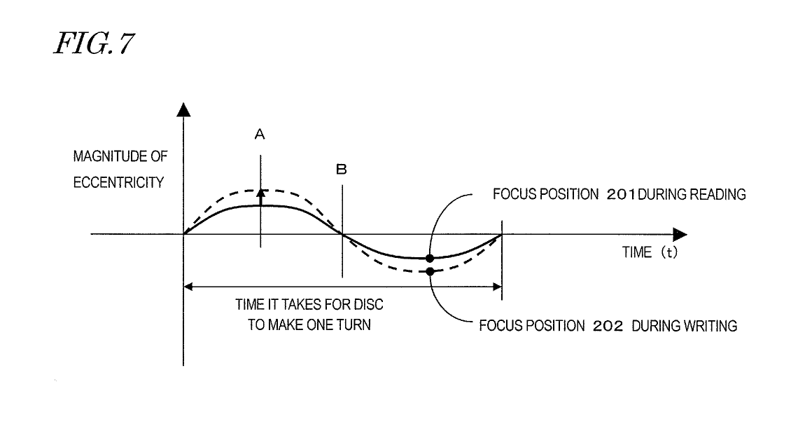

As can be seen easily from the foregoing description and the arrangement shown in FIG. 1, the reflective mirror 136 is arranged on the optical path between the blue LD 102 and the objective lens 132, and the chromatic aberration compensation element 137 is arranged closer to the blue LD 102 than the reflective mirror 136 is. The chromatic aberration compensation element 137 is arranged separately from the objective lens 132, and therefore, is never driven along with the objective lens 132 by the actuator 133. That is to say, since the relative positions of the chromatic aberration compensation element 137 and the objective lens 132 may change, the situations shown in FIGS. 6(b) and 6(d) could arise.

The signal processing section 122 receives the RF signal and retrieves and decodes the data, information and address information included in the RF signal.

The servo section 123 receives the FE and TE signals and generates control signals to control the actuators 133 and 110. In accordance with these control signals, the positions of the objective lens 132 and the beam expander 109 are controlled so that the light radiated from the optical pickup device 200 is incident on the optical disc 101 after having been focused to an appropriate degree to read and write data. On top of that, the servo section 123 also controls the rotational frequency of the spindle motor 116.

In this preferred embodiment, circuit components for performing TE signal related processing are illustrated as a functional block called “tracking control section 123a”, which receives the TE signal and generates a control signal for controlling the actuator 133 that changes the position of the objective lens 132.

The signal processing section 122 and the servo section 123 are implemented as a chip circuit called an “optical disc controller”, in which pre-installed is a program for receiving the TE, FE and RF signals and generating necessary control signals from them. For that purpose, either a dedicated IC on the optical disc controller or a digital signal processor (DSP) performs multiple lines of processing in parallel, thereby generating the control signals. Thus, the tracking control section 123a can be said as formally extracting such TE signal processing related functions. Such processing is actually carried out by a dedicated IC or a DSP for performing FE signal processing and other kinds of processing in parallel.

The laser driver section 125 controls the power of the laser beam emitted by the blue LD 102 to perform a read/write operation. As described above, the laser driver section 125 changes the power to a predetermined recording power when information needs to be written and changes the power to another predetermined readout power when information needs to be read. The recording power is generally higher than the reading power.

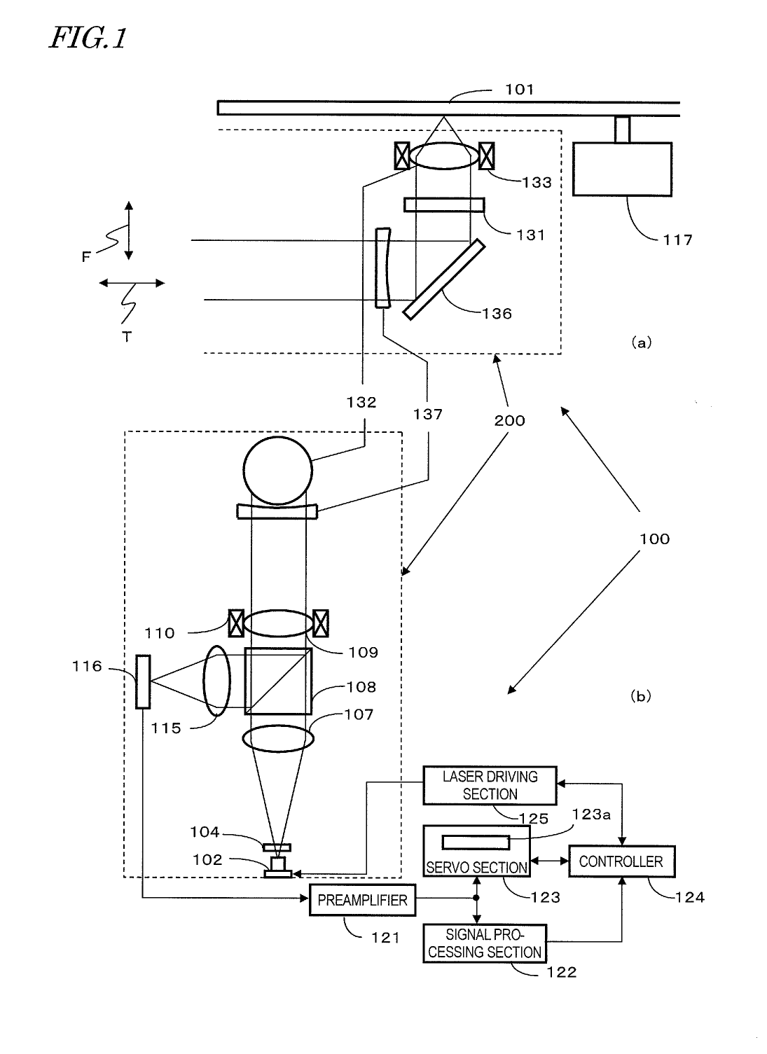

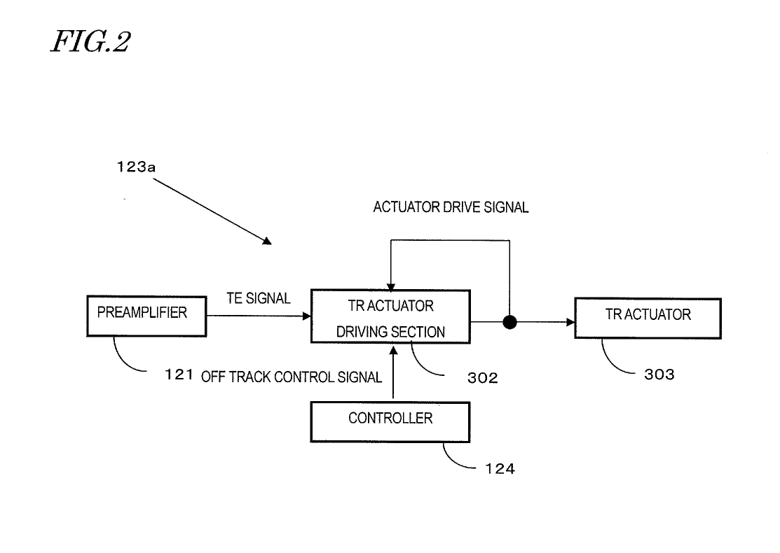

FIG. 2 illustrates a detailed configuration for the tracking control section 123a in the servo section 123. The preamplifier 121 generates the TE signal. A tracking actuator driving section 302 generates an actuator drive signal based on the TE signal, thereby driving a tracking actuator 303. The tracking actuator driving section 302 receives not only the actuator drive signal but also an off-track control signal from the controller and uses these signals to control the off-track. The tracking actuator 303 is a part of the actuator 133 that controls the position of the objective lens 132 in the tracking direction.

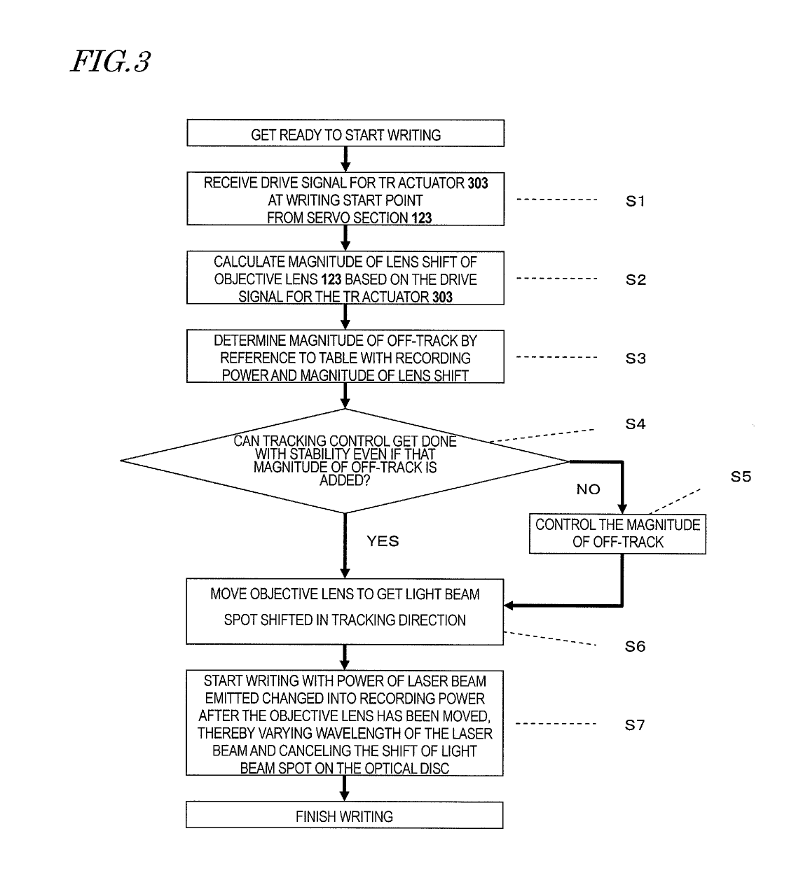

FIG. 3 is a flowchart showing the procedure of the processing carried out by the optical disc drive 100 to get such a control done. On the other hand, FIG. 4 shows the waveform of the TE signal before and after a write operation is started to get that control done. In the following description, a write operation is supposed to be started when the power of the laser beam emitted is changed from the readout power into the recording power.

Hereinafter, it will be described with reference to FIGS. 3 and 4 how the optical disc drive 100 gets its processing done.

First, in Step S1, before the write operation is started, the controller 124 receives a drive signal for the tracking actuator 303 at a writing start point from the servo section 123. Next, in Step S2, the controller 124 calculates the magnitude of lens shift of the objective lens 123 based on the drive signal for the TR actuator 303.

Then, in Step S3, the controller 124 determines the magnitude of off-track by reference to a table that is stored in itself. As used herein, the “table” is a compilation of data representing the relation between the recording power for writing, the magnitude of lens shift, and the magnitude of off-track. On the other hand, the “magnitude of off-track” refers to how much the objective lens 132 needs to be moved in the tracking direction. The magnitude of off-track can be obtained easily by reference to the table with the recording power and the magnitude of lens shift.

Subsequently, in Step S4, the controller 124 determines whether or not the tracking control can still get done with good stability even if the magnitude of off-track determined is added to the magnitude of lens shift. If the answer is YES, the process advances to Step S6. Otherwise, the process advances to Step S5.

The processing step S5 is carried out if the magnitude of off-track is significant. That is why in Step S5, the controller 124 reduces the magnitude of off-track so that the tracking control can get done safely.

In Step S6, the controller 124 not only outputs the off-track control signal but also provides information about the magnitude of off-track for the TR actuator driving section 302. By reference to that information, the tracking actuator driving section 302 generates an actuator drive signal and supplies it to the tracking actuator 303. In accordance with this actuator drive signal, the tracking actuator 303 changes the position of the objective lens 132 in the direction and by the magnitude specified. As a result, the light beam spot on the optical disc moves. At this point in time, however, the blue LD 102 is still emitting a laser beam with the readout power.

In the next processing step S7, after the objective lens 132 has finished moving (i.e., at a writing start point A shown in FIG. 4), the controller 124 supplies a writing control signal to the laser driver section 125. In accordance with the writing control signal, the laser driver section 125 changes the reading power, which has been used to read data, into the recording power and starts a write operation. When the write operation is started, the wavelength of the laser beam varies, and the light beam spot on the optical disc 101 also moves instantaneously. As a result, the focus position shift in the tracking direction can be canceled. After that, the write operation is carried on.

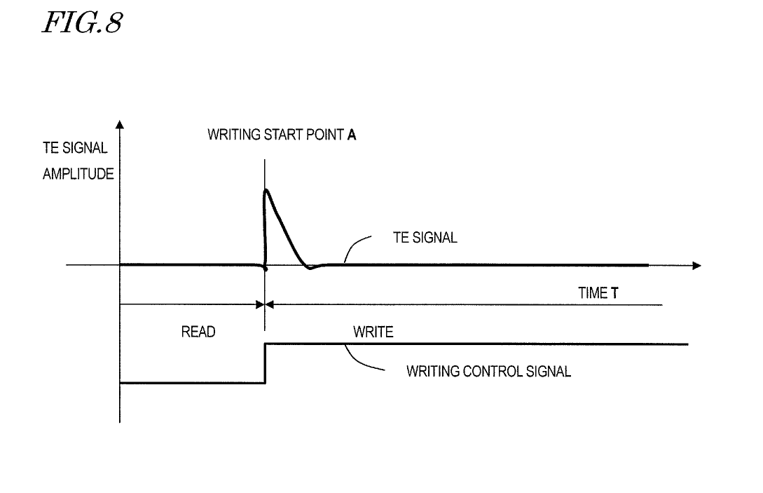

When the write operation is started, the TE signal has already been subjected to the off-track control. That is why compared to the TE waveform shown in FIG. 8, the offset after the write operation has been started has been either canceled completely or at least reduced significantly. Then, data can start being written on the optical disc without disturbing the tracking control at all.

In FIG. 4, the dashed curve shows what the waveform is like unless the off-track control of the present invention is carried out, and is the same as what is shown in FIG. 8.

In the processing step S4 described above, the magnitude of the off-track control to apply is preferably at most one-fourth of the guide groove pitch of the optical disc 101.

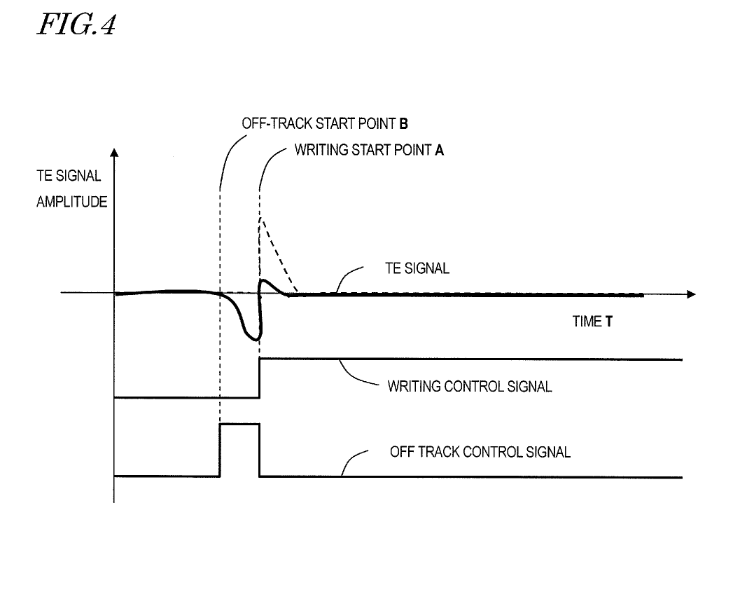

FIG. 5 illustrates how the light beam spot moves on the optical disc 101 when a write operation is performed with the power of the laser beam emitted changed from the readout power into the recording power.

First of all, while a read operation is performed, the light beam spot is right on the target guide groove 800 on the optical disc as indicated by the open circle 801. But when the objective lens 132 starts changing its position after that in response to the off-track control signal, the light beam spot moves from the encircled position 801 to another encircled position 802.

And the instant the objective lens 132 finishes moving and the power of the laser beam emitted is changed into the recording power, the light beam spot moves to another encircled position 803. After that, the write operation is performed with the target guide groove on the optical disc scanned with the light beam spot as indicated by the open circle 804.

The time to output the off-track control signal in the processing step S6 shown in FIG. 3 is preferably at least several ms to several hundred μs earlier than the time to change the power of the laser beam emitted from the readout power into the recording power. This is because by doing that, the timing to change the power of the laser beam is never missed and the position of the objective lens 132 can be changed as intended before the power of the laser beam emitted is changed. It should be noted that the optical disc drive 100 is well aware of the timing to change the modes of operation from reading into writing, and therefore, can generate the off-track control signal before changing the modes.

Also, as for how much the objective lens 132 should be moved in the tracking direction in the processing step S3 shown in FIG. 3 (i.e., as for the magnitude of the off-track control to apply), it depends on not only the NAs, refractive indices and wavelength dependences of the objective lens and the chromatic aberration compensation element and the relation between the power of the laser beam emitted and the magnitude of its wavelength variation, but also the magnitude of the lens shift of the objective lens at that timing to start the write operation (or the magnitude of eccentricity of the optical disc). The relation between the magnitude of the lens shift and the magnitude of offset for the objective lens with respect to the recording power (or a function representing such a relation) could be stored in advance in a memory (not shown) in the controller 124. Alternatively, such a relation could also be confirmed by performing a test write operation on a writing learning area on the optical disc before the write operation is started. For example, such data can be stored in the tracking actuator driving section 302 and may be referred to when the actuator drive signal needs to be generated.

TABLE 1

| | | Variation (mW) in power of laser beam | | | | | | |
|---|---|---|---|---|---|---|---|---|
| | | emitted during writing | | | | | | |
| | | 0 | 5 | 10 | 15 | 20 | 25 | . . . |
| Misalignment | −200 | −e0 | −e1 | −e2 | −e3 | −e4 | −e5 | . . . |
| (μm) between | −150 | −d0 | −d1 | −d2 | −d3 | −d4 | −d5 | . . . |
| optical axes of | −100 | −c0 | −c1 | −c2 | −c3 | −c4 | −c5 | . . . |
| objective lens | −50 | −b0 | −b1 | −b2 | −b3 | −b4 | −b5 | . . . |
| and chromatic | 0 | a0 | a1 | a2 | a3 | a4 | a5 | . . . |
| aberration | 50 | b0 | b1 | b2 | b3 | b4 | b5 | . . . |
| compensation | 100 | c0 | c1 | c2 | c3 | c4 | c5 | . . . |
| element | 150 | d0 | d1 | d2 | d3 | d4 | d5 | . . . |
| | 200 | e0 | e1 | e2 | e3 | e4 | e5 | . . . |

This Table 1 is an example of the table to be stored in a memory in the controller 124. Table 1 defines the magnitude of offset for the objective lens. The magnitude of the offset is determined by the variation in the power of the laser beam emitted and the magnitude of misalignment between the respective optical axes of the objective lens and the chromatic aberration compensation element when the modes of operation are changed from reading into writing. This data is preferably actually measured and stored while the optical pickup device 200 or the optical disc drive 100 is assembled or tested. Alternatively, the average of multiple values that have been obtained by making measurements on multiple optical pickup devices or optical disc drives could also be retained. Still alternatively, a value obtained by optical analysis could also be retained. In any case, to save the memory space to consume, it is preferred that such data be stored as approximation function in the memory.

As described above, the magnitude of lens shift of the objective lens 132 can be detected by reference to the actuator drive signal. As the actuator drive signal to monitor, a signal that has been passed through a band-pass filter, operating around the rotational frequency of the optical disc, or a low-pass filter with an operating frequency of several kHz is preferably used.

The optical disc drive of the preferred embodiment described above is supposed to use a blue LD as its only light source. However, the present invention is applicable no less effectively to an optical disc drive that uses a red LD or an infrared LD. Also, in an optical disc drive that includes a blue LD, a red LD and an infrared LD, before the power of the laser beam emitted from the blue LD is changed from the readout power into the recording power, the position of the objective lens may be changed in the tracking direction. It should be noted that the laser beams emitted from the blue, red and infrared LDs have wavelengths that fall within blue, red and infrared wavelength ranges, respectively, in the ascending order.

If such a control is carried out, the magnitude of offset appearing in the TE signal when a write operation is started can be reduced. As a result, the tracking control can get done with good stability and the quality of recording can be improved when the write operation is started.

The present invention can be used in an optical disc drive that can get a tracking control done on an optical disc such as a BD-R or a BD-RE with good stability and that can also read and write information from/on it. Also, since the present invention will achieve even more significant effect when applied to an optical pickup device that does not includes any chromatic aberration compensation element in its actuator, the present invention contributes greatly to realizing an optical pickup device with a reduced thickness.

What is claimed is:

1. An optical disc drive comprising:
at least one light source;
an objective lens configured to focus light that has been emitted from the at least one light source;
a chromatic aberration compensation element, which is arranged on an optical path between the at least one light source and the objective lens in order to compensate for chromatic aberration that has been produced by the objective lens; and
an actuator configured to change a position of the objective lens,
wherein the actuator changes the position of the objective lens in a tracking direction by a magnitude of an offset, which is determined by a variation in wavelength of the light to be produced when a power of the light emitted from the at least one light source changes.

2. The optical disc drive of claim 1, wherein relative positions of the objective lens and the chromatic aberration compensation element change.

3. The optical disc drive of claim 1, further comprising a mirror, which is arranged on the optical path between the at least one light source and the objective lens,
wherein the chromatic aberration compensation element is arranged between the at least one light source and the mirror.

4. The optical disc drive of claim 1, further comprising an actuator driving section configured to determine the magnitude of the offset by magnitude of the variation in the wavelength of the light and magnitude of misalignment between the optical axes of the objective lens and the chromatic aberration compensation element.

5. The optical disc drive of claim 4, wherein the actuator driving section determines the magnitude of misalignment between the optical axes of the objective lens and the chromatic aberration compensation element by a drive voltage applied to the actuator.

6. The optical disc drive of claim 5, further comprising:
a controller configured to generate a writing control signal; and
a laser driver section configured to change the power of the light emitted from the light source in accordance with the writing control signal,
wherein before the laser driver section changes the power of the light emitted, the actuator driving section changes the position of the objective lens in the tracking direction, and
wherein after the position of the objective lens has been changed, the controller generates the writing control signal and the laser driver section changes the power of the light emitted.

7. The optical disc drive of claim 6, wherein before the power of the light emitted is changed, the controller outputs an off-track control signal to the actuator driving section to instruct the actuator driving section to change the position of the objective lens, and
wherein on receiving the off-track control signal, the actuator driving section changes the position of the objective lens in the tracking direction.

8. The optical disc drive of claim 6, wherein after the position of the objective lens has been changed, the controller generates the writing control signal to change the power of the light emitted from a readout power into a recording power.

9. The optical disc drive of claim 6, wherein the at least one light source includes a first light source configured to emit light with a first wavelength and a second light source configured to emit light with a second wavelength, which is shorter than the first wavelength, and
wherein when the second light source emits the light with the second wavelength,
the actuator changes the position of the objective lens in the tracking direction by the magnitude of an offset, which is determined by a variation in the second wavelength to be produced when the power of the light emitted from the second light source changes.

10. The optical disc drive of claim 4, wherein data defining a relation between the magnitude of the variation in the wavelength of the light, the magnitude of misalignment between the optical axes of the objective lens and the chromatic aberration compensation element, and the magnitude of the offset is stored in advance in a tracking control section, which determines the magnitude of the offset by reference to that data.
